(19) United States
(12) Patent Application Publication
(10) Pub. No.: US 2011/0038153 A1
(43) Pub. Date: Feb. 17, 2011

(54) Led lamp and cooling method thereof

(76) Inventor: Sheng-Hsiung Hu, Shanhua Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/585,166

(22) Filed: Sep. 8, 2009

(30) Foreign Application Priority Data
Aug. 12, 2009 (TW) 98127158

(51) Int. Cl. F21S 4/00

(52) U.S. Cl. 362/249.02; 362/373

(57) ABSTRACT

A cooling method for an LED lamp is disclosed. An LED lamp is provided. The LED lamp includes a housing and at least one LED light source module. The housing has a cover body, a base and a plurality of air outlets. The base forms at least one segment difference portion. The slanted surface of the segment difference portion has a plurality of air inlets. The LED light source module is adjacent to the air inlets. The LED light source module has a cooling device and the cover body has a plurality of air outlets. Airflow is guided into the cooling space along the air inlet on the slanted surface of the segment difference portion. When the LED lamp generates heat, air entered into the cooling space is blown to the cooling device. The airflow with heat is exhausted from the air outlet of the cover body.

### BACKGROUND OF THE INVENTION

1. Field of the Invention

The present invention relates to an LED lamp and a cooling method thereof. In particular, the present invention relates to an LED lamp that dissipates heat smoothly, distributes the flow field uniformly, and reduce cost and weight and a cooling method thereof.

2. Description of Related Art

Because LED has a lot of merits, such as brightness is high, consumption power is low, and usage life is long, etc, LED is popularly applied to a variety of lighting devices, such as an LED streetlamp for lighting a road. When LED is lighting, a great amount of heat is generated so that a cooling device is required to dissipate the heat. Therefore, LED can light under a proper temperature and does not burn down. When the cooling device is not designed well, high temperature will lower the brightness of LED, reduce the usage life, and change the wavelength.

Reference is made to FIG. 1, the LED lighting device of the prior art has the following problems.

1. The LED lighting device 1a of the prior art usually has a housing 11a and an LED light source device 12a. The LED light source device 12a is directly pasted onto the housing 11a. The light source emits from the bottom of the housing 11a. The housing 11a has a cooling fin 111a with a large dimension to directly exhaust heat to air. However, dust will be accumulated on the housing 11a to affect the cooling effect. Moreover, the thickness of the housing 11a needs to be increased to make the heat be distributed uniformly and the housing 11a is made of heat-conductive metal. The cost and the weight increases.

2. A cooling pipe (not shown in the figure) is used to dissipate the heat of the LED. That will increase the cost and it is difficult to maintain the LED lighting device. Furthermore, due to the system dimension is increased and the LED lighting device becomes complex, it is not to assemble the LED lighting device.

3. Reference is made to FIG. 2. The LED lighting device 2a of the prior art includes a housing 21a and an LED light source device 22a. The bottom of the housing 21a is flat. The bottom of the housing 21a has an air inlet 211a. The LED light source device 22a is located in the housing 21a. When air is blown into the lamp via the air inlet 22a (the airflow path is shown in the figure), part of the LED light source device 22a cannot be blown by air to form a death zone of airflow. The cooling effect is affected.

### SUMMARY OF THE INVENTION

One particular aspect of the present invention is to provide an LED lamp and a cooling method thereof. The LED lamp can dissipate heat smoothly, distribute the flow field uniformly, be easily manufactured, reduces cost and weight, and be expanded.

The LED lamp includes a housing having a cover body and a base, and at least one LED light source module. The cover body is located at the base. The cover body and the base form a cooling space. The base has at least one segment difference portion. The segment difference portion has a plurality of air inlets. The LED light source module is adjacent to the air inlets. The LED light source module includes an optical device and a cooling device. The cooling device is located on the optical device.

The present invention also provides a cooling method for an LED lamp and includes the following steps.

An LED lamp is provided. The LED lamp includes a housing and at least one LED light source module. The housing has a cover body and a base. The base forms at least one segment difference portion. The slanted surface of the segment difference portion has a plurality of air inlets. The LED light source module is adjacent to the air inlets. The LED light source module has a cooling device for dissipating heat generated from the LED lamp to air. The cover body has a plurality of air outlets.

Air is guided into the cooling space formed by the cover body and the base along the air inlet on the slanted surface of the segment difference portion.

When the LED lamp generates heat, air entered into the cooling space is blown to the cooling device along the direction of airflow to dissipate heat.

The airflow with heat is exhausted to outside air from the air outlet of the cover body.

The present invention has the following characteristics.

1. The base has a segment difference portion. The air inlet on the slanted surface of the segment difference portion can guide airflow into the cooling space formed by the cover body and the base to make the cooling airflow smoothly, reduce death zone, and enhance the cooling effect. The quantity of cooling fins can be reduced, and the manufacturing cost and the weigh are also reduced.

2. When the quantity of the LED light source modules is increased, each of the LED light source modules is located at the corresponding air inlet to directly guide airflow to cool the LED light source module. The cooling conditions for each LED light source module are the same to balance the temperature.

3. In addition to cool the LED light source module, the air inlet on the segment difference portion also forms another airflow to cool the adjacent LED light source module to enhance the cooling effect.

4. The LED light source module is a module design, and can be added according to the requirement and expanded.

5. The segment difference portion can be easily manufactured. The segment difference portion has the air inlet to dissipate heat by utilizing the natural convention. No fan is required. The cost is low and the usage life becomes longer.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a schematic diagram of the LED lamp of the prior art;

FIG. 2 is a schematic diagram of the LED lamp of another prior art;

FIG. 3 is a flow chart of the cooling method for an LED lamp of the present invention;

FIG. 4 is a perspective view of the LED lamp of the present invention;

FIG. 5 is another perspective view of the LED lamp of the present invention;

FIG. 6 is a perspective view of part of the LED lamp of the present invention; and

FIG. 7 is a schematic diagram of the LED lamp of the present invention when the cover body is opened; and

FIG. 8 is a cross-sectional view of the LED lamp of the present invention.

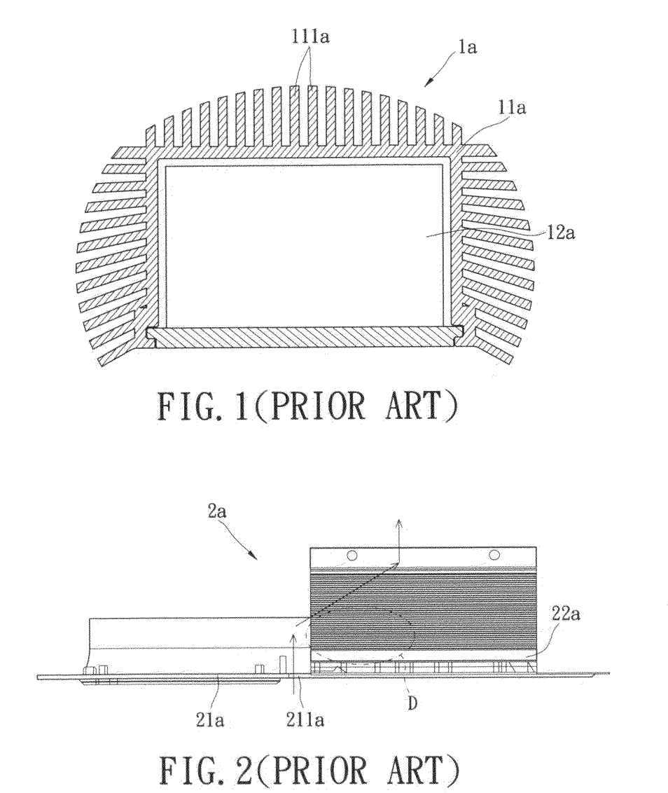

### DETAILED DESCRIPTION OF THE PREFERRED EMBODIMENTS

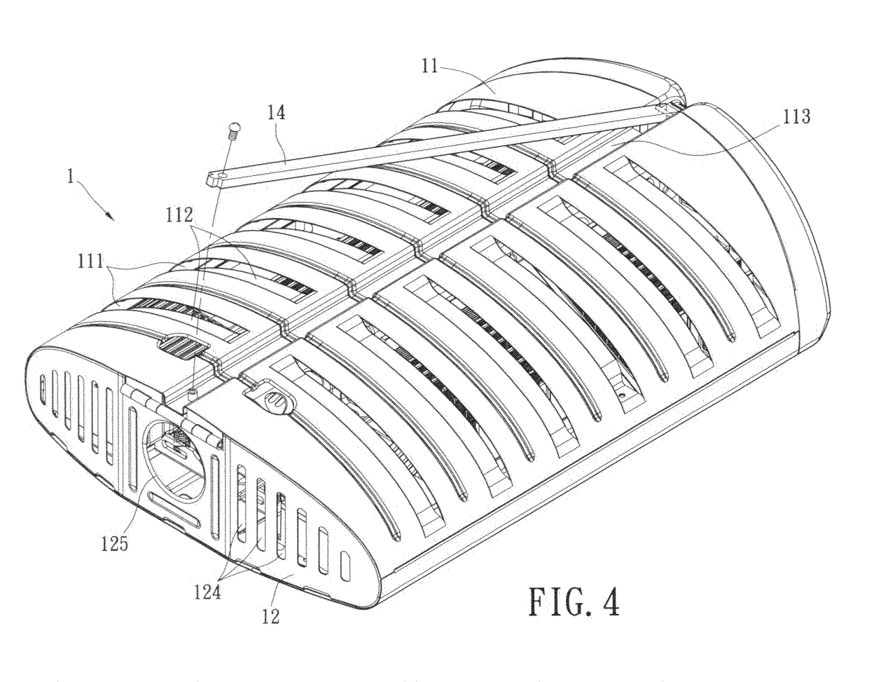

Reference is made to FIGS. 4˜8. The LED lamp includes a housing 1, at least one LED light source module 2 and a power supply 3.

The housing 1 is hollow and is made of metal or plastic. The housing 1 includes a cover and 11 and a base 12. In this embodiment, the cover body is pivoted with the base, but not limited to above. The cover body 11 and the base 12 form a cooling space 13.

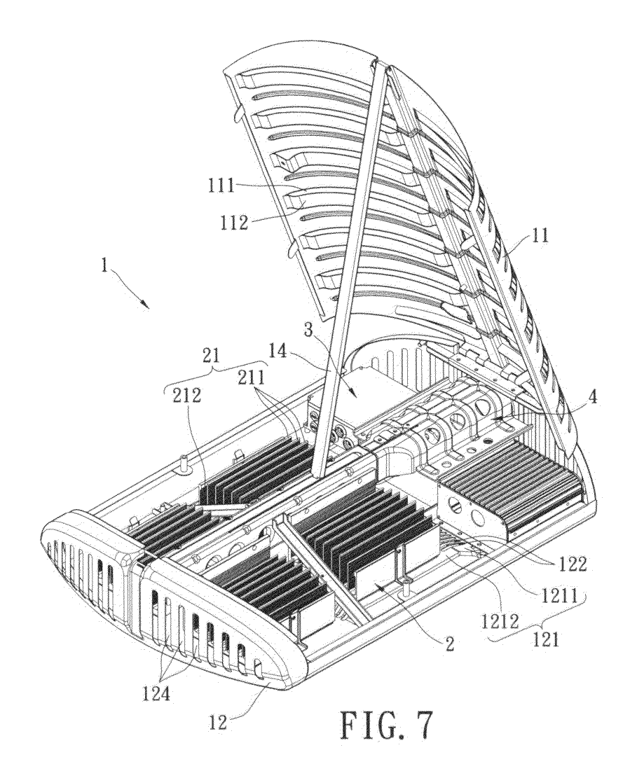

The cover body 11 has a plurality of air outlets 111, a plurality of concave portions 112 and a trough 113. The air outlets 111 of the cover body 11 are rectangular and are disposed at the top of the cover body 11 at interval and located at two sides of the trough 113. The concave portions 112 are respectively located at the air outlets 111 and its height is lower than the height of the cover body 11 to prevent dust or rain from entering into the housing 1. The trough 113 can receive a support rod 14. One end of the support rod 14 is pivoted with one end of the cover body 11, and another end of the support rod 14 is locked with another end of the cover body 11 via a screw (as shown in FIG. 4). When the cover body 11 is opened, the support rod 14 is rotated to make one end of the support rod 14 be supported on the base (as shown in FIG. 7). It is easy to maintain the LED lamp.

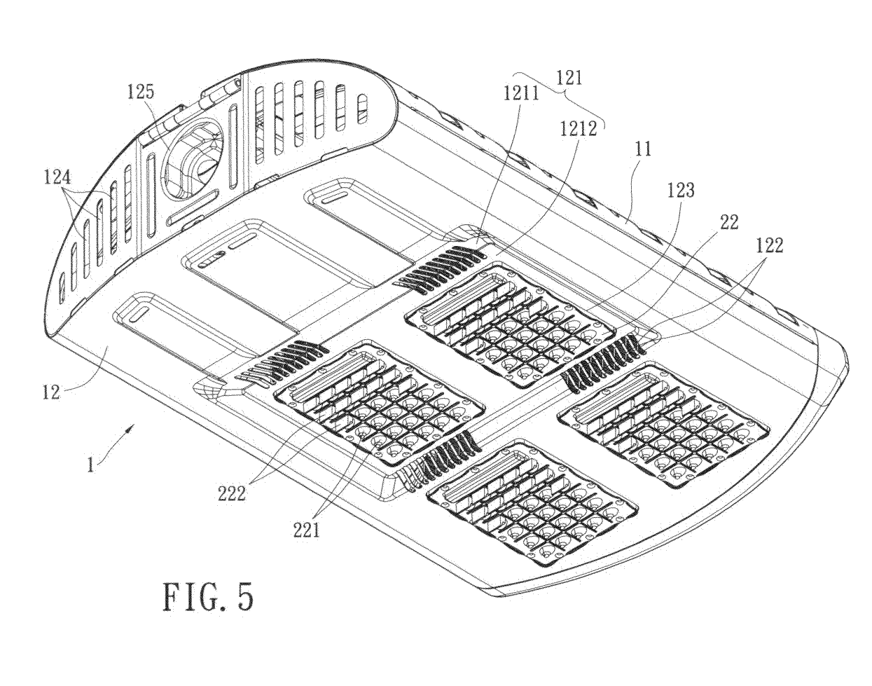

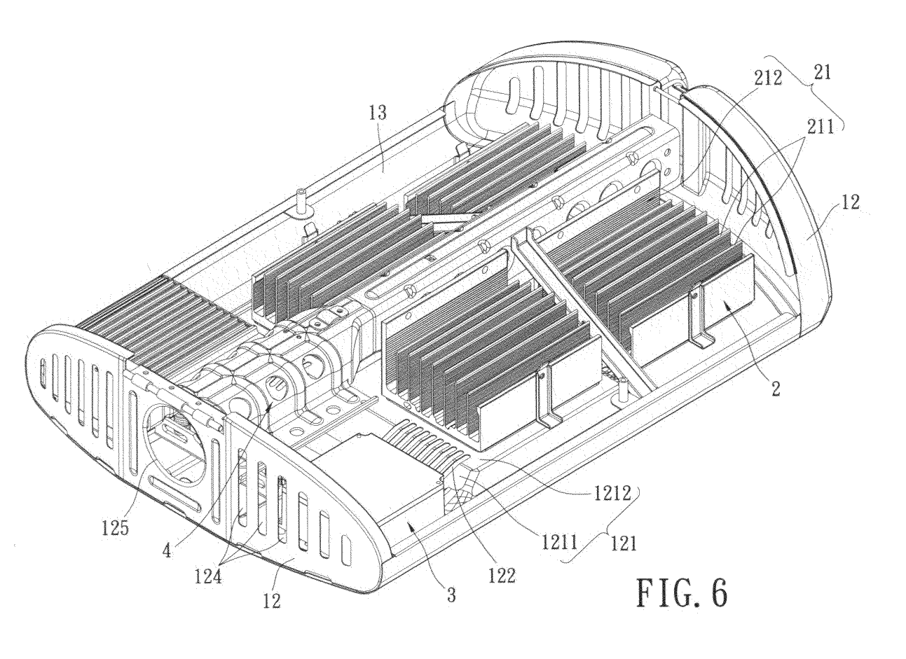

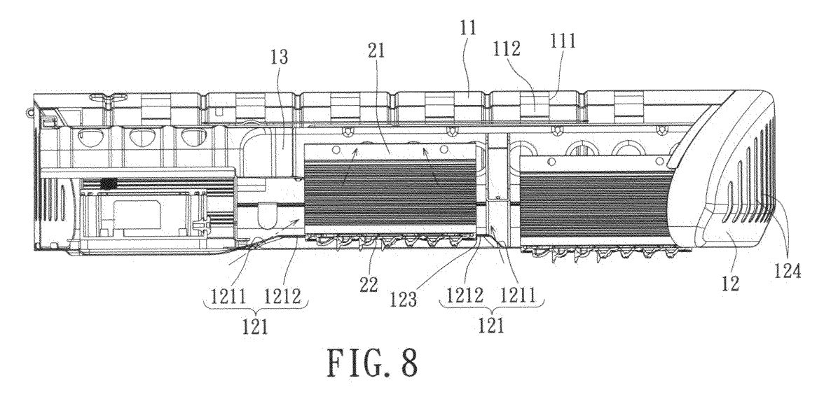

The base 12 has at least one segment difference portion 121. In this embodiment, there are four segment difference portions 121 (as shown in FIG. 5). The four segment difference portions 121 are disposed two by two and are adjacent to each other. Each of the segment difference portions 121 includes a slanted surface 1211 and a flat surface 1212. The slanted surface 1211 is connected with the flat surface 1212. The slanted surface 1211 has a plurality of air inlets 122 disposed at intervals. The flat surface 1212 has an opening 123. The air inlets 122 are adjacent to the opening 123. The slanted surface 1211 can guide airflow to enter the cooling space 13 via the air inlet 122 along the slanted surface 1211. Reference is also made to FIG. 8. The heights of the flat surface 1212 of the segment difference portion 121 located at the front side of the LED lamp and the flat surface 1212 of the segment difference portion 121 located at the rear side of the LED lamp are different. Both are connected by the slanted surface 1211.

In this embodiment, there are four LED light source modules 2. Each of the LED light source modules 2 includes a cooling device 21 and an optical device 22. The cooling device 21 is located at the optical device 22. The cooling device 21 is made of aluminum that is a heat-conductive material for absorbing heat. The cooling device 21 has a plurality of cooling fins 211, and the cooling fins 211 are disposed at intervals and in a high-to-low status. The surface of the cooling fins 211 has a plurality of wave-shaped structures 212 to increase the cooling area.

The optical device 22 is transparent, and is rectangular. The bottom of the optical device 22 has a plurality of light-adjusting structures 221 and a plurality of polarizing structures 222 (as shown in FIG. 5), and LEDs are included (not shown in the figure). The light-adjusting structures 221 and the polarizing structures 222 extend to outside of the opening 123. The light-adjusting structures 221 are core-shaped and their locations correspond to the LED for focusing the light source and increase the brightness. The polarizing structures 222 are flake-shaped, and vertically located at one side of part of the light-adjusting structures 221 for adjusting the direction of light source to light the target area.

The power supply 3 is located in the base 12 to provide power to the four LED light source modules 2.

The base 12 further has a support structure 4. The support structure 4 is column-shaped, and extends from one end of the base 12 to another end. The LED light source modules 2 are symmetrically locked at two sides of the support structure 4. The front and rear sides of the base 12 have a plurality of cooling openings 124 to enhance the cooling effect. Therefore, the LED lamp has a good cooling effect under different slanted angles. The center of the rear side of the base 12 has a circular installation hole 125 for installing the support column of the lamp.

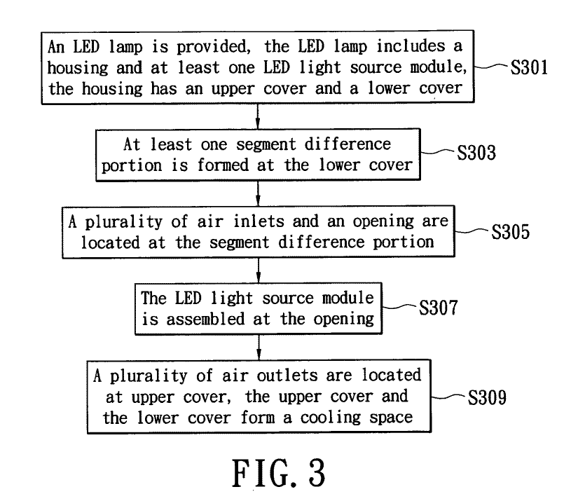

Reference is made to FIGS. 3, and 4˜8. The present invention also provides a cooling method for an LED lamp and includes the following steps.

S301: An LED lamp is provided.

The LED lamp includes a housing 1, at least one LED light source module 2, and a power supply 3. The structure of the housing 1, the LED light source module 2, and the power supply 3 are the same as the previous description and not repeated again.

S303: Airflow is guided into the cooling space 13 formed by the cover body 11 and the base 12 via the air inlet 122 along the slanted surface 1211 of the segment difference portion 121.

S305: When the LED lamp generates heat, airflow entered into the cooling space 13 is blown to the cooling device 21 along the direction of airflow to dissipate heat.

S307: The airflow with heat is exhausted to outside air from the air outlet 111 of the cover body 11.

The present invention has the following characteristics.

1. The base 12 has a segment difference portion 121. The slanted surface 1211 of the segment difference portion 121 has air inlet 122. The LED light source module 2 is located at the opening 123 of the flat surface 1212 of the segment difference portion 121, and is adjacent to the air inlet 122. Thereby, airflow enters into the cooling space 13 via the air inlet 122 along the slanted surface 1211, and can be smoothly blown to the cooling fins 211. The heat is exhausted from the air outlet 111 of the cover body 11. Death zone is reduced, and the cooling effect is enhanced. The quantity of cooling fins 211 can be reduced, and the manufacturing cost and the weigh are also reduced.

2. When the quantity of the LED light source modules 2 is increased, each of the LED light source modules 2 is located at the corresponding air inlet 122 to directly guide airflow to cool the LED light source module 2. The cooling conditions for each LED light source module 2 are the same to balance the temperature.

3. In addition to cool the LED light source module 2, the air inlet 122 on the slanted surface 1211 of the segment difference portion 121 also forms another airflow to cool the adjacent LED light source module 2 to enhance the cooling effect.

4. The LED light source module 2 is a module design. When the required brightness increases, the quantity of the segment difference portion 121 and the LED light source module 2 is increased and expanded.

5. The segment difference portion 121 can be easily manufactured. By utilizing the natural convention, no fan is required. The cost is low and the usage life becomes longer.

6. Around the air outlet 111, there is a streamline shaped concave portion 112. The height of the concave portion 112 is lower than the height of the cover body 11 so that dust or rain cannot directly enter into the housing 1 to achieve the dust-proof effect and the waterproof effect.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A cooling method for an LED lamp, comprising:
providing an LED lamp, wherein the LED lamp includes a housing and at least one LED light source module, the housing has a cover body, a base and a plurality of air outlets, the base forms at least one segment difference portion, a slanted surface of the segment difference portion has a plurality of air inlets, the LED light source module is adjacent to the air inlets, and the LED light source module has a cooling device for absorbing heat;
guiding airflow into the cooling space formed by the cover body and the base along the air inlet on the slanted surface of the segment difference portion;
when the LED lamp generates heat, air entered into the cooling space is blown to the cooling device along the direction of airflow to dissipate heat; and
exhausting the airflow with heat to outside air from the air outlet of the cover body.

2. An LED lamp, comprising:
a housing having a cover body, a base and a plurality of air outlets, wherein the cover body is located at the base, the cover body and the base form a cooling space, the base has at least one segment difference portion, and the segment difference portion has a plurality of air inlets; and
at least one LED light source module, wherein the LED light source module is adjacent to the air inlets, the LED light source module includes an optical device and a cooling device, and the cooling device is located on the optical device.

3. The LED lamp as claimed in claim 2, wherein the segment difference portion includes a slanted surface and a flat surface, the slanted surface is connected with the flat surface, the air inlets are located at the slanted surface, the flat surface has an opening, and the LED light source module is assembled around the opening.

4. The LED lamp as claimed in claim 2, wherein the air outlets has a plurality of concave portions, the height of the concave portion is lower than the height of the cover body.

5. The LED lamp as claimed in claim 2, wherein two sides of the base have a plurality of cooling openings.

6. The LED lamp as claimed in claim 2, wherein the cooling device has a plurality cooling fins, the cooling fins are disposed at intervals, and the surface of the cooling fins has a plurality of wave-shaped structures.

7. The LED lamp as claimed in claim 2, wherein the base further has a support structure, and the LED light source module is locked at one side of the support structure.

8. The LED lamp as claimed in claim 2, wherein the cover body has a trough, the trough is received with a support rod, and one end of the support rod is pivoted with one end of the cover body.

9. The LED lamp as claimed in claim 2, wherein the optical device includes a plurality of light-adjusting structures and a plurality of polarizing structures, and the polarizing structures are located at one side of part of the light-adjusting structures.
